(19) United States
(12) Patent Application Publication
(10) Pub. No.: US 2009/0042429 A1
(43) Pub. Date: Feb. 12, 2009

(54) Sealed Connection Device and Sealed Connector Counterpart

(76) Inventors: Frederic Chazottes, Houx (FR); Christian Campfort, Fresnay le Gilmert (FR)

Correspondence Address: HARRINGTON & SMITH, PC, 4 RESEARCH DRIVE, Suite 202, SHELTON, CT, 06484-6212, US

(21) Appl. No.: 11/883,660

(22) PCT Filed: Jan. 31, 2006
(86) PCT No.: PCT/EP2006/000809

§ 371 Date: Feb. 8, 2008

(30) Foreign Application Priority Data
Feb. 4, 2005 (FR) 05 01155

(51) Int. Cl. H01R 13/52

(52) U.S. Cl. 439/271

(57) ABSTRACT

The invention concerns an electrical connection device including a connector having electrical contacts, a connector counterpart having complementary electrical contacts, designed to be coupled to the connector along a coupling axis (X-X), an annular seal. The connector counterpart includes a support for said electrical contacts onto which the seal is fitted and a housing for receiving at least one part of the support, and the housing and the connector each have a peripheral support surface onto a first area and onto a second area of said seal, which areas are adjacent. The invention also concerns a connector counterpart.

The present invention concerns a sealed connection device and a sealed connector counterpart, designed particularly for use in the automobile industry.

In particular, the invention relates to a sealed connection device of the type comprising:
a connector having electrical contacts,
a connector counterpart designed to be coupled to the connector along a coupling axis and having complementary electrical contacts provided to be coupled to the electrical contacts of the first connector, and
an annular seal.

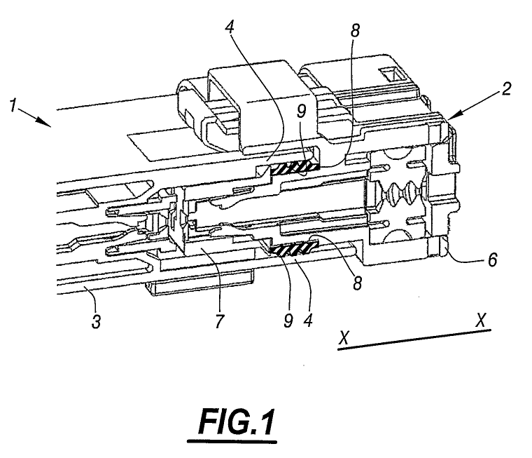

A device of this type is shown in FIG. 1. It comprises a connector 1 provided to be coupled to a connector counterpart 2 along a coupling axis, which is represented by the X-X axis in FIGS. 1, 2, 3 and 6.

In the description that follows, the terms “axial” and “transverse” are to be understood relative to this X-X axis. Likewise, the terms “outside” and “inside” designate any part or surface positioned in an eccentric manner, or in a centered manner, respectively, relative to this X-X axis.

Connector 1 and connector counterpart 2 are each connected to one end of an electrical cable that is not shown, and each bears its own metal contacts that can cooperate to connect the electrical cables together.

In FIG. 1, connector 1 is coupled to connector counterpart 2.

It comprises a body part 3 of a generally parallelepiped shape whose outer walls extend axially in the direction of connector counterpart 2 to form a tulip 4.

Connector counterpart 2 comprises a base 6 of a generally parallelpiped shape that has a central axial projection extending in the direction of connector 1 and forming a male connection element 7.

This male connection element 7 can be introduced into a skirt 4, when connector 1 and connector counterpart 2 are coupled.

A recess 8, which is created on the outer faces of male connection element 7, is designed to receive a sealing gasket 9 in the form of a sleeve, called in the following description an “interface seal”.

This interface seal 9 prevents moisture from infiltrating into connector counterpart 2 and connector 1 by the contact of the seal, on the one hand, with the surfaces of recess 8 of the male connection element and, on the other hand, with the inner faces of skirt 4. Sealing is therefore assured between seal 9 and connector counterpart 2, as well as between seal 9 and connector 1.

Nevertheless, this application requires that the contact surfaces between interface seal 9 and connector counterpart 2 are perfect in quality. In particular, no flash or deformation is tolerated on the surfaces of recess 8. Mould parting line at the level of these surfaces is therefore strongly advised against and shrink mark are prohibited.

This solution, currently mastered for the molding of skirt 4 of the connector, is extremely constraining with regard to the design of the mold for connector counterpart 2. In fact, a specific molding process must be implemented in order to allow the molding of the surfaces of recess 8 in a single block for receiving the interface seal.

The object of the invention is to propose a sealed connection device that is easy to mold.

For this purpose, the subject of the invention is a connection device of the above-mentioned type, characterized in that the connector counterpart comprises a support for said electrical contacts onto which the sealing gasket is fitted and a reception housing for at least one part of the support, and in that the housing and the connector each have a peripheral support surface onto a first and a second area of the seal, which areas are adjacent.

According to particular embodiments, the device has one or more of the following characteristics:
the housing and the connector are able to exert a compressive force on said first and second areas of the seal to form a continuous surface between said seal and the connector, on the one hand, and the connector counterpart, on the other hand, said compressive force being exerted perpendicularly to said axis of coupling;
the connector comprises a tulip that extends axially, said tulip having said peripheral support surface;
a reception recess for the seal is created in either the connector or the connector counterpart;
the housing comprises at least one stop piece for positioning the support relative to the housing, and the recess is formed in said support at a predefined distance from said stop piece, so that said peripheral support surface of the housing is supported on said first area of the seal;
said seal comprises at least two projecting sealing lips, one formed on said first area and the other formed on said second area of the seal, and the housing and the connector are able to exert said compressive force on said sealing lips;
a sealing lip formed on said first area and a sealing lip formed on said second area bound a central zone of the seal, and the central zone of the seal is positioned at right angles to a water infiltration space created between a surface of the connector in contact with a surface of the connector counterpart to form a barrier seal;
said seal comprises two additional projecting sealing lips, one formed on the first area and the other formed on the second area of the seal, on either side of the sealing lips, said additional lips bounding two peripheral sealing zones that form two safety barrier seals;
the housing comprises a skirt extending axially, said skirt being able to cooperate with said tulip of the first connector, and said skirt comprising attachment means and said tulip comprising complementary attachment means to attach the connector to the connector counterpart; and
the support comprises several independent electrical modules that can be mounted in said housing.

A subject of the invention is also a sealed connector counterpart designed to be coupled with a connector having electrical contacts, said connector counterpart comprising:
electrical contacts provided to be coupled to the electrical contacts of the first connector,
an annular seal,

characterized in that it has a support for said electrical contacts on which the seal is fitted and a reception housing for at least a part of the support, and in that the housing has a peripheral surface supported on a first area of the seal, and in that a second area of the seal is provided to be in contact with said connector.

The invention will be better understood upon reading the description that follows, given solely by way of example and made by referring to the attached drawings, in which:

FIG. 1 is a perspective view, in partial section along a transverse plane, of a sealed connection device according to the prior art;

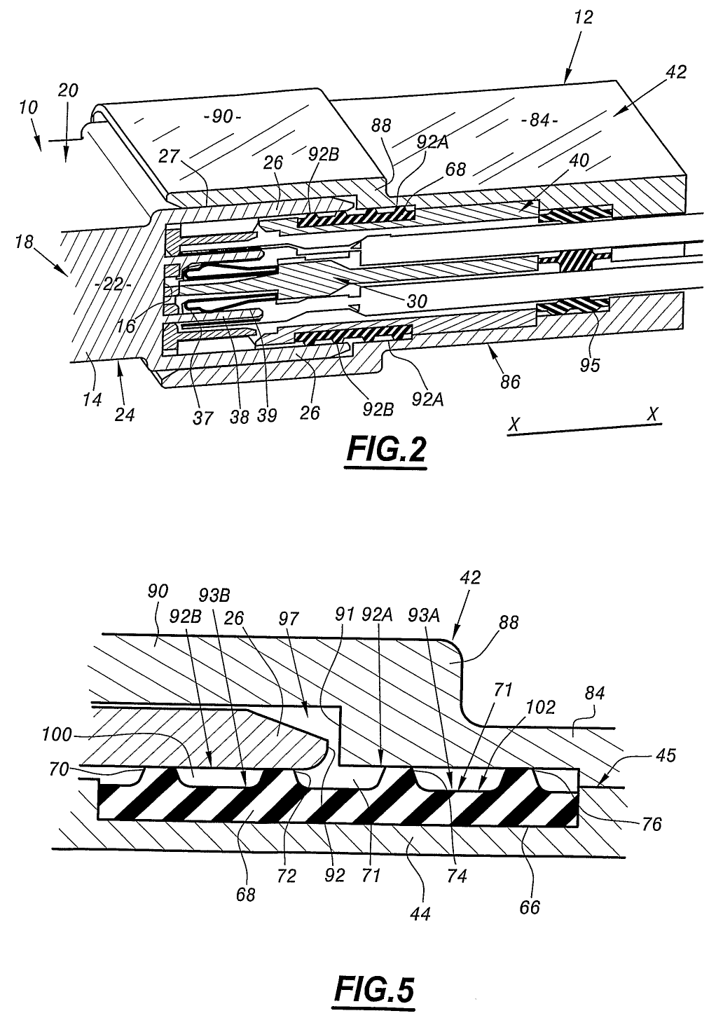

FIG. 2 is a view similar to the view of FIG. 1 of a first embodiment of the sealed connection device according to the invention;

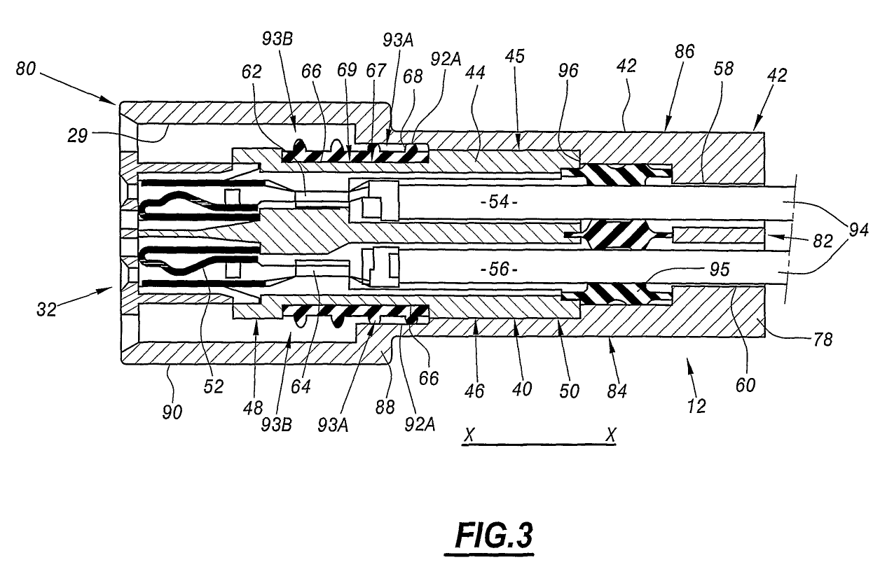

FIG. 3 is a sectional view of a connector counterpart of the sealed connection device, according to the first embodiment;

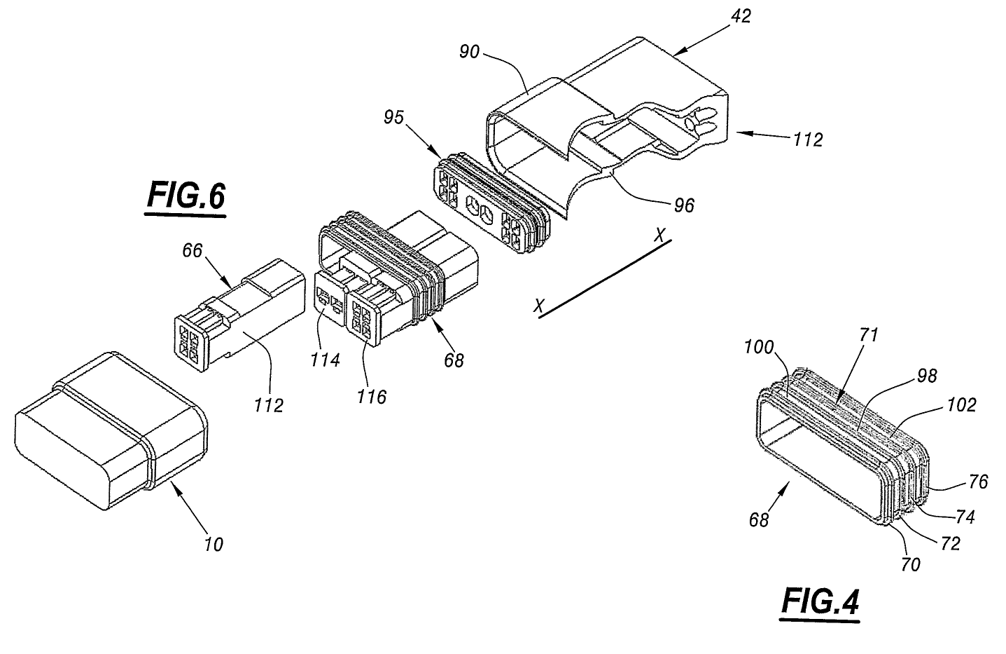

FIG. 4 is a perspective view of a seal that can be mounted in the sealed connection device, illustrated in FIGS. 2 and 5;

FIG. 5 is an enlarged view of a detail of FIGS. 1, 2 and 3; and

FIG. 6 is an exploded perspective view, with the housing partially torn away, of a second embodiment of the sealed connection device according to the invention.

The sealed connection device according to the first embodiment of the invention is illustrated schematically in FIG. 2.

The device has a connector 10 and a connector counterpart 12 designed to mate with connector 10. In FIG. 2, connector counterpart 12 is mated with connector 10.

Connector 10 comprises a parallepiped body part 14 having a face 16 that can be coupled to connector counterpart 12, called “front face”, a face 18 opposite the front face called “rear face” and axial walls 20, 22, 24.

Axial walls 20, 22, 24 of body part 14 are extended to form a tulip 26.

This tulip 26 constitutes a female mating element 30 provided to receive a male mating element 32 of the connector counterpart, as explained in the description that follows.

Tulip 26 has means 27 for attaching connector 10 to complementary attachment means 29 of connector counterpart 12, as explained in the description that follows.

Connector 10 also comprises, on its front surface 16, a positioning grid 37 and tabs 38 supporting flexible electrical contact plates 39 connected to electrical cables, not shown in FIG. 2.

Positioning grid 37, molded of plastic, permits adjusting the positioning of connector 10 relative to connector counterpart 12, during their coupling.

Connector counterpart 12, shown in FIG. 3, comprises a support 40 for electrical contact elements and a housing 42 that is adapted to contain a portion of support 40.

Support 40 is made up of a base 44 of elongated parallelepiped shape, having four axial walls 45, 46, a front part 48 forming male connection element 32 designed to be encased in tulip 26 of the connector, and a rear part 50 opposite the front part.

Base 44 bears a positioning grid 52, for electrical cables 54, 56 mounted in axial openings 58, 60 and terminals 62, 64 electrically connected to cables 54, 56.

In a manner known in and of itself, positioning grid 52 is attached to the end of front part 48 of the support and can cooperate with positioning grid 37 of the connector.

In a manner known in and of itself, terminals 62 and 64 are made up of flexible electrical contact plates that can come into contact with the flexible electrical contact plates 39, of complementary shape, attached onto tabs 38 of the connector.

Base 44 has a groove 66 formed on the outer faces of these four walls 45, 46.

This groove 66 constitutes a reception recess for an interface annular seal 68, made of elastomer, which can assure the seal between connector 10 and connector counterpart 12.

According to the invention, a part 67 of groove 66 is formed in rear part 50 of the support that is introduced into housing 42. The other part 69 of groove 66 is formed in the front part 48 of the support that extends to the outside of the housing. Preferably, each part 67, 69 of the groove has a width that corresponds to half the total width of groove 66.

Interface seal 68, shown in FIG. 4, has the general shape of a sleeve, one surface 71 of which, called the sealing face, is provided with four flanges 70, 72, 74, 76 projecting radially, also called “sealing lips”.

Interface seal 68 is fitted onto base 44 so that sealing face 71 is not in contact with the surface of groove 66.

Electrical contacts 62, 64, and complementary electrical contacts 39 should be insulated from external moisture and contamination.

Housing 42 has the general shape of a parallelepiped body part 78 having a front face 80, a solid rear wall 82 and four solid axial walls 84, 86.

In the example of the invention shown in FIGS. 2 and 3, housing 42 has a transverse shoulder 88 on its front face 80, at the end of each of these four walls 84, 86, and this shoulder is extended axially by a skirt 90.

Shoulder 88 is positioned so that its inner surface constitutes a stop surface 91 for the end of tulip 26, when connector counterpart 12 is coupled to connector 10.

Skirt 90 bears attachment means 29 provided to cooperate with complementary attachment means 27 borne by tulip 26 of the connector. These attachment means 29 consist of gluing means.

As a variant, attachment means 29 and complementary attachment means 27 are made up of clamping, clipping, elastic interlocking, etc., means.

Solid rear wall 82 of the housing comprises transverse holes 94 aligned with openings 58, 60 of the support and permitting the passage of electrical cables 54, 56, and a reception recess for a wire sealing or grommet 95, mounted around electrical cables 54, 56 to assure the seal between cables 54, 56 and body part 78 of the housing.

The four axial walls 84, 86 of the housing form an envelope having an opening on the front face 80 of the housing, provided to receive rear part 50 of the support.

Front part 48 of the support that is not introduced into housing 42, forms male connection element 32, which can be introduced into tulip 26.

The inner faces of walls 84, 86 of the housing have a flange 96 forming a stop piece for rear part 50 of the support. This flange 96 is positioned at a predefined distance from shoulder 88, so that an inner peripheral face 92A of walls 84, 86 is supported on a first area 93A of face 71 of the interface seal.

In particular, peripheral face 92A of the housing is supported on two lips 74, 76 of the interface seal, situated on the side of the housing.

Tulip 26 of the connector has a length such that its inner peripheral face 92B can come to be supported on a second area 93B of face 71 of the interface seal.

In particular, peripheral face 92B of the tulip is supported on the other two lips 70, 72 of the interface seal, situated on the side of connector 10.

A gap 97 for water infiltration, called “water infiltration space” below, is defined between stop surface 91 of the housing and the end of tulip 26 of the connector. This space 97 is positioned facing a central zone 98 borne by two central lips 72, 74 of the interface seal.

Since the two central lips 72, 74 are positioned on either side of infiltration space 97, the central zone 98 and the lips 72, 74 form a barrier seal for water discharge.

Each of the two peripheral lips 70, 76 with one of the two central lips 72, 74, bounds two peripheral zones 100, 102. Peripheral zones 100, 102 and lips 70, 72, 74, 76 form two safety barrier seals.

Support surface 92B of tulip 26 and support surface 92A of the housing are able to exert a compressive force on lips 70, 72, 74, 76 perpendicular to the direction of coupling X-X of connector 10 to connector counterpart 12.

For this purpose, the dimensions of housing 42, the depth of groove 66, the thickness of seal 68 and the offset of tulip 26, are determined so that lips 70, 72, 74, 76 are compressed by support surfaces 92A, 92B of the housing and tulip 26, in order to assure a sealed continuity, on the one hand, between seal 68 and housing 42, and on the other hand, between seal 68 and connector 10.

Consequently, seal 68 perfectly and continuously matches the surfaces of housing 42 and tulip 26 even when these surfaces have irregularities due to a problem with molding of the parts.

FIG. 5* shows a second embodiment of the invention. *sic; FIG. 6?—Trans. note.

In this embodiment, connector counterpart 112 differs from connector counterpart 12 of the first embodiment essentially in that support 40 comprises three independent electrical modules 112, 114, 116 that can be mounted in housing 42.

The outer walls of each of these electrical modules 112, 114, 116 comprise a groove 66 that can receive the seal 68.

On its inner surface, housing 42 has a flange 96 forming a stop piece for electrical modules 112, 114, 116.

As a variant, the seal 68 has only two lips, 72, 74 defining a single central sealing zone 98.

As a variant, housing 42 does not have skirt 90.

As a variant, housing 42 is mounted in one piece with support 40.

Advantageously, the connection device according to the invention is easy to mount. In fact, during mounting, support 40 bearing electrical cables 54, 56, seal 68 and rear seal 95 is mounted in housing 42. Then connector counterpart 12 is attached to connector 10.

Advantageously, the compressive force of sealing lips 70, 72, 74, 76 of seal 68 is applied along a plane perpendicular to coupling axis X-X of connector 10 and of the connector counterpart. Consequently, the tolerances on the parts are less critical.

1. A sealed electrical connection device comprising:
a connector having electrical contacts,
a connector counterpart designed to be coupled to connector along a coupling axis (X-X), and having complementary electrical contacts provided to be coupled to electrical contacts of first connector,
an annular seal,
characterized in that connector counterpart comprises a support for said electrical contacts onto which seal is fitted and a reception housing for at least a part of support, and in that housing and connector each have a peripheral support face onto a first and onto a second area of seal, which areas are adjacent.

2. The connection device according to claim 1, further characterized in that housing and connector can exert a compressive force on said first area and second area of seal to form a continuous surface between said seal and connector, on the one hand, and connector counterpart, on the other hand, said compressive force being exerted perpendicularly to said coupling axis (X-X).

3. The connection device according to claim 1, further characterized in that connector comprises a tulip which extends axially, said tulip having said peripheral support surface.

4. The connection device according to claim 1, further characterized in that a reception recess for seal is created in either connector or connector counterpart.

5. The connection device according to claim 4, further characterized in that housing comprises at least one stop piece for positioning support relative to housing and in that recess is formed in said support at a predefined distance from said stop piece, so that said peripheral support face of said housing is supported on said first area of said seal.

6. The connection device according to claim 2, further characterized in that said seal comprises at least two projecting sealing lips, one formed on said first area and the other formed on said second area of seal, and in that housing and connector are able to exert said compressive force on said sealing lips.

7. The connection device according to claim 6, further characterized in that a sealing lip formed on said first area and a sealing lip formed on said second area bound a central zone of seal, and in that the central zone of seal is positioned at right angles to a water infiltration space created between a face of connector in contact with a face of connector counterpart to form a barrier seal.

8. The connection device according to claim 6, further characterized in that said seal comprises two additional projecting sealing lips one formed on the first area and the other on the second area of sealing gasket, on either side of sealing lips, said additional lips defining two peripheral sealing zones that form two safety barrier seals.

9. The connection device according to claim 3, further characterized in that housing comprises a skirt extending axially, said skirt being able to cooperate with said tulip of said first connector, and in that said skirt comprises attachment means and said tulip comprises complementary attachment means to attach connector to connector counterpart.

10. The connection device according to claim 1, further characterized in that support comprises several independent electrical modules that can be mounted in said housing.

11. A sealed connector counterpart designed to be coupled with a connector having electrical contacts, said connector counterpart comprising:
electrical contacts provided to be coupled with electrical contacts of said first connector,
an annular seal,
characterized in that it has a support for said electrical contacts onto which seal is fitted and a reception housing for at least a part of support and in that housing has a peripheral face supported on a first area of seal, and in that a second area of seal is provided to be in contact with said connector.
